(19) United States
(12) Patent Application Publication
(10) Pub. No.: US 2003/0060351 A1
(43) Pub. Date: Mar. 27, 2003

(54) Blank and method for forming a novelty product

(76) Inventors: Irving R. Michlin, Salt Point, NY (US); Stephen A. Singer, Wheeling, IL (US)

Correspondence Address: Francis C. Hand, Esq., c/o Carella, Byrne, Bain, Gilfillan,, Cecchi, Stewart & Olstein, 6 Becker Farm Road, Roseland, NJ, 07068, US

(21) Appl. No.: 09/966,039

(22) Filed: Sep. 27, 2001

(51) Int. Cl. B31B 1/26

(52) U.S. Cl. 493/405

(57) ABSTRACT

A single blank is provided with four removable sections which are sub-divided by lines of weakening and fold lines. The blank is foldable along a longitudinal line and transverse line to form the four sections into a four layer product. Upon removable from the blank, the four layer product may be manipulated to expose different sub-sections and, thus, provide different pictorial representations depending upon the imaging of the sub-sections. The sub-sections are imaged in a coordinated manner to produce different scenes.

This invention relates to a blank and a method for forming a novelty product.

As is known, various types of novelty products have been made from paper materials to provide various pictorial effects. One known novelty product is in the form of a small rectangular card of multi-layer construction which is divided into foldable sections and imaged differently on each section to present a different pictorial representation when the folded sections are manipulated into different orientations.

It is an object of this invention to provide a blank for making a novelty product as well as a method for forming the novelty product from the blank in a relatively easy and simple manner.

Briefly, the invention provides a blank that is comprised of a single-ply or sheet of paper having four removable rectangular sections disposed in discrete areas of the sheet. In addition, each removable section is provided with fold lines and lines of weakening to divide the section into sub-sections.

In addition, adhesive is disposed over the backside of the various sub-sections while removable liners are disposed over the adhesive areas in order to protect the adhesive. Accordingly, the liner may be provided with a layer of silicone or other release material to be peelable from the adhesive on the sub-section. In addition, a second adhesive, for example, in the form of glue dots, are provided on each of the four corner sub-sections of two aligned removable sections or permanent securement to the backing layer disposed thereover for removable therewith.

The blank is sized to be imaged or printed, for example, in an ink-jet printer or laser printer or any other suitable type of device, to have various pictorial representations or text or photographs made on each of the four removable sections and particularly within one or more of the sub-sections.

After imaging, the blank is processed so that each backing liner is removed from the back of the blank to expose the adhesive. At the same time, one of the liners also removes four corner sub-sections from each of two aligned removable sections to provide “windows” in these sections.

Next, the sheet of paper is folded about a longitudinal line of weakening to secure the pairs of removable sections on each half of the sheet of paper over the removable sections of the other half of the sheet of paper. The windows which are provided in two of the sections thus expose the adhesive on the opposed surfaces of the other sections.

Next, the sheet of paper is folded about a transverse line of weakening to secure the folded sections together.

Finally, the removable sections are removed as a single unit from the remainder of the blank to define a novelty product having multiple foldable sections. Formation of the novelty product from a single sheet of paper allows the paper to be readily imaged with whatever pictorial representations are to be displayed when the novelty product has been manipulated by a user.

These and other objects and advantages of the invention will become more apparent from the following detailed description taken in conjunction with the accompanying drawings wherein:

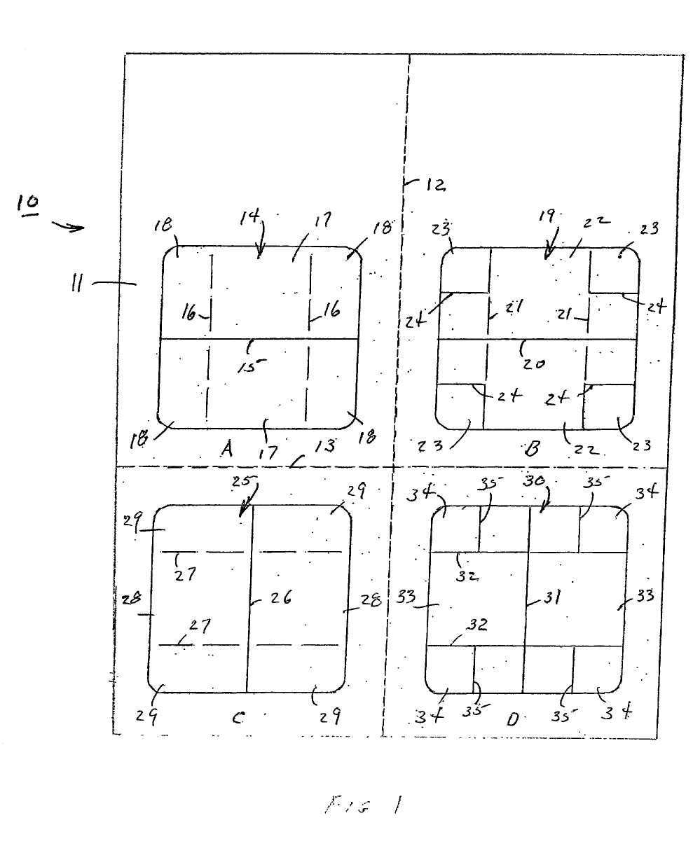

FIG. 1 illustrates a front view of a blank for making a novelty product in accordance with the invention;

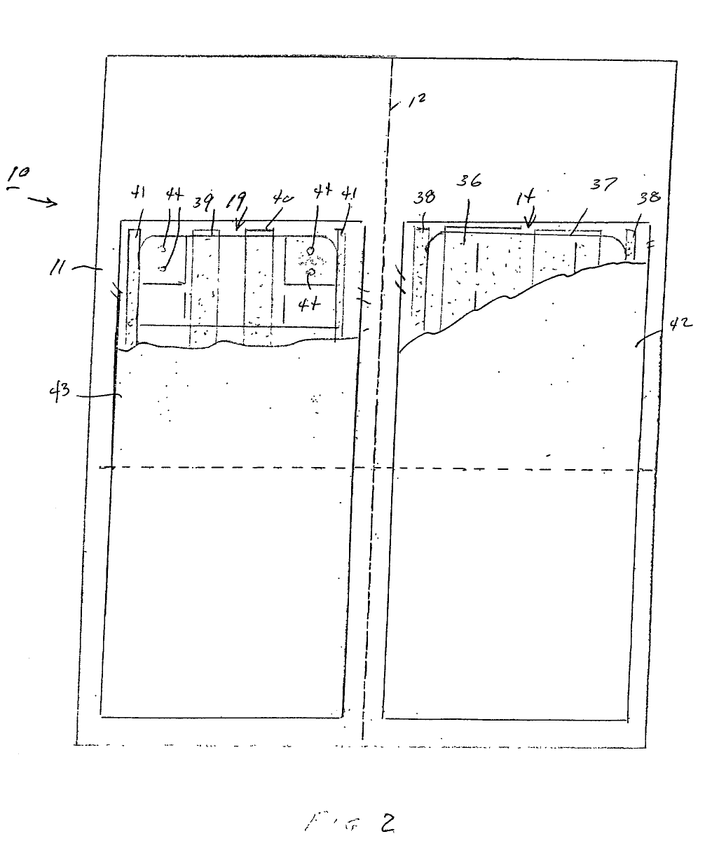

FIG. 2 illustrates a view of the back side of the blank of FIG. 2; and

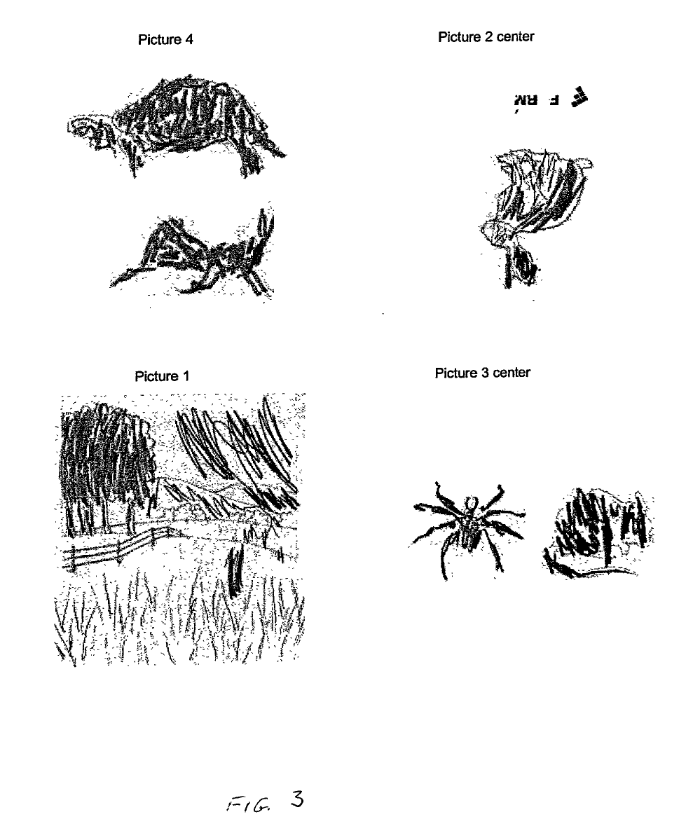

FIG. 3 illustrates a view similar to FIG. 1 of a blank having pictoral representations formed on the four removable sections.

Referring to FIG. 1, the blank 10 is comprised of a single sheet of paper 11 having a longitudinally disposed line of weakening 12 to divide the sheet 11 in half and a transverse line of weakening 13 extending across the sheet 11 to define four areas A, B, C, D within the sheet 11.

The first area A has a removable rectangular section 14 defined by a die-cut, perforations, or by slits with rupturable ties or the like suitable to allow the section 14 to be subsequently removed. The section 14 includes a slit line 15 with or without rupturable ties perpendicular to the longitudinal line 12 to divide the section 14 in half. In addition, the rectangular section 14 includes a pair of interrupted lines of weakening 16 parallel to the longitudinal line 12 and perpendicular to the slit line 15. Each interrupted line 16 has four spaced-apart segments to divide the section 14 into a pair of main sub-sections 17 and two pairs of side sub-sections 18.

Area B is disposed on an opposite side of the longitudinal line 12 from area A and has a removable rectangular section 19 including a slit line 20 perpendicular to the longitudinal line 12 to divide the section 19 in half. In addition, the section 19 has a pair of interrupted lines of weakening 21 parallel to the longitudinal line 12 and perpendicular to the slit line 20. Each interrupted line 21 has four spaced-apart segments to divide the section 19 into a pair of main sub-sections 22 and two pairs of side sub-sections 23. In addition, a slit line 24 with or without rupturable ties is provided in each side sub-section 23 to divide the side sub-section 23 in half.

Area C, which is on the same side of the longitudinal line 12 as section A, has a removable third section 25 including a slit line 26 parallel to the longitudinal line 12 to divide the section 25 in half. In addition, the section 25 has a pair of interrupted lines of weakening 27 perpendicular to the longitudinal line 12 and perpendicular to the slit line 26. Each interrupted line 27 has four spaced-apart segments to divide the section 25 into a pair of main sub-sections 28 and two pairs of side sub-sections 29.

The fourth area D is disposed on an opposite side of the longitudinal line 12 from area C and has a removable fourth rectangular section 30 including a slit line 31 parallel to the longitudinal line 12 to divide the section 30 in half. In addition, the section 30 has a pair of interrupted lines of weakening 32 perpendicular to the longitudinal line 12 and perpendicular to the slit line 31. Each interrupted line 32 has four spaced-apart segments to divide the section 30 into a pair of main sub-sections 33 and two pairs of side sub-sections 34. A slit line 35 with or without rupturable ties is provided in each sub-section 34 to divide the sub-section 34 in half.

Referring to FIG. 2, adhesive is disposed over the back of the sheet of paper 11 in patterns, for example, stripes, to cover over selected sub-sections of each removable section 14, 19, 25, 30. Specifically, two parallel continuous stripes 36, 37 of adhesive are applied over the removable sections 14, 25 to substantially cover all of the sub-sections thereof. As indicated, the two stripes 36, 37 of adhesive are parallel to the longitudinal line 12 of the sheet 11. Two narrower stripes of adhesive are disposed in parallel to the stripes 36, 37 outside the plane of the removable sections 14, 25 for purposes as described below. Alternatively, the adhesive may be applied to fully cover the areas of the sections 14,19,25,30 that are to be laminated together.

A pair of narrower parallel stripes of adhesive 39, 40 are disposed over the removable sections 19, 30. As indicated, these stripes of adhesive 39, 40 are parallel to the longitudinal line of weakening 12 of the sheet 11. Each strip of adhesive 39, 40 is of a width to cover over only one half of a main sub-section 22 of the removable section 19 and the middle half of the removable section 30. Additional lines of adhesive 41 are provided in parallel to the lines of adhesive 39, 40 and are located outside the plane of the removable sections 19, 30 for purposes as described below.

Alternatively, stripes of adhesive may also be applied over the remaining subsections of the removable sections 19, 30 to enhance adhesive securement of the various sections together as explained below.

Referring to FIG. 2, a pair of removable backing sheets or liners 42, 43 are provided to protect the adhesive on the sheet of paper 11. Each removable backing 42, 43 is particularly held in place by the strips of adhesive 38, 41 alongside the removable sections 14, 19. The backing sheets 42, 43 may be made of any suitable material, such as a silicone-coated paper. Alternatively, the two backing sheets 42, 43 may be replaced by a single backing sheet.

As indicated in FIG. 2, additional adhesive 44 in the form of a pair of dots 44 is applied to the sub-sections at the four corners of the removable sections 19, 30. These adhesive dots 44 serve to secure one-half of each sub-section 23, 34 (FIG. 1) to the backing sheet 43 in a permanent manner.

In order to form a novelty product, the two backing sheets 42, 43 are removed from the back of the blank 10 to expose the adhesive strips. During removal of the backing sheet 43, one-half of each side sub-section 23 of the removable sections 19, 30 is simultaneously removed. Upon removal of each corner of the removable section 19, 30, a “window” is formed.

Thereafter, the sheet of paper 11 is folded about the longitudinal line of weakening 12 to adhesively secure sections 14 and 19 over each other and sections 25 and 30 over each other. At this time, the windows provided in the sections 19, 30 expose the adhesive on the four corners of the opposite sections 14, 25.

Next, the sheet 11 is folded about the transverse line of weakening 13 to adhesively secure four corners of the first section 14 to and over four corners of the third section 25. In this respect, the windows provided by the two sections 19, 30 allow communication between the adhesive on the exposed surfaces of the sections 14, 25.

Thereafter, the four folded-over sections are removed from the sheet of paper 11 to define a novelty product having a four-layer construction with multiple foldable sections.

Once formed, the product may be folded about the now aligned slit lines 15, 20 of the first and second section 14,19 to break apart each of the sections 14, 19 into two halves and then folded about the slit lines 26,31 of the third and fourth sections 25,30 to separate each of the sections 25, 30 into two halves.

The product may then be manipulated by a user by folding about the slit lines 15, 26 to expose the different sub-sections to thereby present a rectangular pictorial representation, which may change, depending upon the sub-sections exposed to view.

The product may be printed with indicia on each of the four sections 14, 19, 25, 30 that are coordinated to each other so as to present coordinated scenes on the foldable sections of the product.

Referring to FIG. 3, each removable section 14, 19, 25, 30 is provided with a different pictorial representation from the other. When folded and manipulated by a user, different scenes may be depicted from time to time.

The blank may be formed with eight or more removable sections in order to form two or more multi-layer products rather than only one product. Also, the removable sections may be oriented on the blank in any suitable manner to be imaged, folded over onto another removable section and removed.

The blank may be formed with the removable sections and printed in any suitable fashion. For example, the blank may be pre-die cut or post die cut, printed and adhesively coated. Alternatively, the blank may be printed, then die cut and then adhesively coated and folded. Still further, the blank may be die cut, printed and personalized and then glued and folded.

While the novelty product is illustrated as being of rectangular shape, other shapes are also possible such as oval and circular.

A plurality of blanks may be provided to a consumer who would then print the information desired on the removable sections and then process the form into a plurality of products, each with the same or different imaging. For example, for forwarding to different ultimate consumers.

In another embodiment, the blank may be formed with one or more pairs of separated areas about a fold line with each area having a removable section. For example, one section may have a pictoral representation while the other section has text related to the pictoral representation. In this embodiment, adhesive is applied over one or preferably both removable sections along with a removable backing sheet or sheets as above. After removal of the backing sheet or sheets, the blank is folded about the fold line to laminate the two sections together into a two-ply card that can then be removed from the folded blank.

One advantage of the latter embodiment is that the alignment of the two sections over and onto each other can be readily achieved by a simple folding step.

In still another embodiment, the blank may be in the form of a continuous web on a roll, with or without a fold line, that can be printed and processed into a series of novelty products. For example, a continuous web may be printed and then separated at intervals to form discrete pieces that may then be folded to form one or more novelty products. Also, the web may be processed without the separating step to form a continuous stream from which the novelty products may then be removed.

What is claimed is:

1. A blank for making a novelty product, said blank comprising
a sheet of paper having a longitudinally disposed line of weakening to divide said sheet in half and a transverse line of weakening extending across said sheet to define four areas within said sheet;
a first of said areas on one side of said longitudinal line having a removable rectangular section including a slit line perpendicular to said longitudinal line to divide said section in half, a pair of interrupted lines of weakening parallel to said longitudinal line and perpendicular to said slit line, each interrupted line having four spaced apart segments to divide said section into a pair of main sub-sections and two pair of side sub-sections;
a second of said areas on an opposite side of said longitudinal line from said first area having a removable second rectangular section including a slit line perpendicular to said longitudinal line to divide said second section in half, a pair of interrupted lines of weakening parallel to said longitudinal line and perpendicular to said slit line, each interrupted line having four spaced apart segments to divide said second section into a pair of main sub-sections and two pair of side sub-sections, and a slit line in each side sub-section to divide said side sub-section in half;
a third of said areas on said one side of said longitudinal line having a removable rectangular third section including a slit line parallel to said longitudinal line to divide said third section in half, a pair of interrupted lines of weakening perpendicular to said longitudinal line and perpendicular to said slit line thereof, each interrupted line having four spaced apart segments to divide said third section into a pair of main sub-sections and two pair of side sub-sections; and
a fourth of said areas on an opposite side of said longitudinal line from said third area having a removable fourth rectangular section including a slit line parallel to said longitudinal line to divide said fourth section in half, a pair of interrupted lines of weakening perpendicular to said longitudinal line and perpendicular to said slit line thereof, each interrupted line having four spaced apart segments to divide said fourth section into a pair of main sub-sections and two pair of side sub-sections, and a slit line in each side sub-section thereof to divide said side sub-section in half;
at least a first liner disposed over said first and third rectangular sections;
at least a second liner disposed over said second and fourth rectangular sections;
a layer of adhesive on each area for releaseably holding a respective liner thereon; and
adhesive means securing one-half of each side sub-section of said second and fourth sections to said second liner for removal with said second liner.

2. A blank as set forth in claim 1 wherein said layer of adhesive on said first and third areas covers each of said main sub-sections and said side sub-sections thereof and said layer of adhesive on said third and fourth areas covers only said main sub-sections thereof.

3. A blank as set forth in claim 1 which further comprises a first adhesive-free strip on said sheet parallel to said longitudinal line of weakening and extending centrally of said first and third sections and a second adhesive-free strip on said sheet parallel to said longitudinal line of weakening and extending centrally of said second and fourth sections.

4. A blank for making a novelty product, said blank comprising
a sheet of paper having a first line of weakening to divide said sheet in half to define at least two areas within said sheet;
a first of said areas on one side of said line having a removable section therein for receiving imaging thereon;
a second of said areas on an opposite side of said line from said first area having a removable second section therein spaced from said first section for folding over and onto said first area, said second section having imaging thereon related to the imaging on said first section;
a layer of adhesive on at least one of said sections for laminating said sections to each other; and
a removable liner disposed over said adhesive on said one section.

5. A blank as set forth in claim 4 which further includes at least one second line of weakening transverse to said first line of weakening to define a third area and a fourth area within said sheet for folding, said third area being disposed on an opposite side of said second line from said first area and said fourth area being disposed on an opposite side of said second line from said second area, said third area having a removable section therein and said fourth section having a removable section for folding over and onto said removable section of said third area.

6. A blank as set forth in claim 5 which further comprises a layer of adhesive on at least one of said third and fourth sections for laminating said sections to each other and a removable liner disposed over said adhesive on said at least one of said third and fourth sections.

7. A blank as set forth in claim 6 wherein each of said removable sections of said second and fourth areas have sub-sections adhered to said liner for removal therewith to provide windows in said removable sections of said second and fourth areas for exposure of adhesive therethrough.

8. A blank for making a novelty product, said blank comprising
a sheet of paper having a longitudinally disposed line of weakening to divide said sheet in half and a transverse line of weakening extending across said sheet to define four areas within said sheet;
a first of said areas on one side of said longitudinal line having a removable section including a slit line perpendicular to said longitudinal line to divide said section in half, a pair of interrupted lines of weakening parallel to said longitudinal line and perpendicular to said slit line, each interrupted line having four spaced apart segments to divide said section into a pair of main sub-sections and two pair of side sub-sections;
a second of said areas on an opposite side of said longitudinal line from said first area having a removable second section including a slit line perpendicular to said longitudinal line to divide said second section in half, a pair of interrupted lines of weakening parallel to said longitudinal line and perpendicular to said slit line, each interrupted line having four spaced apart segments to divide said second section into a pair of main sub-sections and two pair of side sub-sections, and a slit line in each side sub-section to divide said side sub-section in half;
a third of said areas on said one side of said longitudinal line having a removable third section including a slit line parallel to said longitudinal line to divide said third section in half, a pair of interrupted lines of weakening perpendicular to said longitudinal line and perpendicular to said slit line thereof, each interrupted line having four spaced apart segments to divide said third section into a pair of main sub-sections and two pair of side sub-sections; and
a fourth of said areas on an opposite side of said longitudinal line from said third area having a removable fourth section including a slit line parallel to said longitudinal line to divide said fourth section in half, a pair of interrupted lines of weakening perpendicular to said longitudinal line and perpendicular to said slit line thereof, each interrupted line having four spaced apart segments to divide said fourth section into a pair of main sub-sections and two pair of side sub-sections, and a slit line in each side sub-section thereof to divide said side sub-section in half;
a liner disposed over said sections;
a layer of adhesive on each area for releaseably holding said liner thereon; and
adhesive means securing one-half of each side sub-section of said second and fourth sections to said liner for removal with said liner.

9. A blank as set forth in claim 8 wherein each said section is rectangular.

10. A method of forming a novelty product comprising the steps of
providing a sheet of paper having a longitudinally disposed line of weakening to divide said sheet in half and a transverse line of weakening extending across said sheet to define four areas within said sheet; a first of said areas on one side of said longitudinal line having a removable section including a slit line perpendicular to said longitudinal line to divide said section in half, a pair of interrupted lines of weakening parallel to said longitudinal line and perpendicular to said slit line, each interrupted line having four spaced apart segments to divide said section into a pair of main subsections and two pair of side sub-sections; a second of said areas on an opposite side of said longitudinal line from said first area having a removable second section including a slit line perpendicular to said longitudinal line to divide said second section in half, a pair of interrupted lines of weakening parallel to said longitudinal line and perpendicular to said slit line, each interrupted line having four spaced apart segments to divide said second section into a pair of main sub-sections and two pair of side sub-sections, and a slit line in each side sub-section to divide said side sub-section in half; a third of said areas on said one side of said longitudinal line having a removable third section including a slit line parallel to said longitudinal line to divide said third section in half, a pair of interrupted lines of weakening perpendicular to said longitudinal line and perpendicular to said slit line thereof, each interrupted line having four spaced apart segments to divide said third section into a pair of main sub-sections and two pair of side sub-sections; a fourth of said areas on an opposite side of said longitudinal line from said third area having a removable fourth section including a slit line parallel to said longitudinal line to divide said fourth section in half, a pair of interrupted lines of weakening perpendicular to said longitudinal line and perpendicular to said slit line thereof, each interrupted line having four spaced apart segments to divide said fourth section into a pair of main sub-sections and two pair of side sub-sections, and a slit line in each side sub-section thereof to divide said side sub-section in half; a liner disposed over said sections; a layer of adhesive on each area for releaseably holding said liner thereon; and adhesive means securing one-half of each side sub-section of said second and fourth sections to said liner for removal with said liner;
removing said liner from said sheet of paper while simultaneously removing one-half of each side sub-section of said second and fourth sections therewith;
thereafter folding said sheet of paper about said longitudinal line of weakening to adhesively secure said first section to and over said second section and to adhesively secure said third section to and over said fourth section; and
thereafter folding said sheet about said transverse line of weakening to adhesively secure said first section to and over said third section.

11. A method as set forth in claim 10 which further comprises the steps of removing said folded over first, second, third and fourth sections from said sheet to define a novelty product having multiple foldable sections.

12. A method as set forth in claim 11 which further comprises the steps of folding said product about said fold line of said first section to separate said first section into two halves and folding said product about said fold line of said third section to separate said third section into two halves.

13. A method as set forth in claim 10 which further comprises the step of printing indicia on each of said first and third sections and printing indicia on each of said main sub-sections of each of said second and fourth sections coordinated to the indicia on said first and third sections to present coordinated scenes on said foldable sections of said novelty product.
